(19) United States
(12) Patent Application Publication
(10) Pub. No.: US 2014/0184078 A1
(43) Pub. Date: Jul. 3, 2014

(54) LIGHT EMITTING DIODE DRIVING DEVICE

(71) Applicant: SAMSUNG ELECTRO-MECHANICS CO., LTD., Suwon (KR)

(72) Inventors: Jong Tae HWANG, Gyunggi-do (KR); Sang Hyun CHA, Gyunggi-do (KR); Chang Seok LEE, Gyunggi-do (KR); Deuk Hee PARK, Gyunggi-do (KR)

(73) Assignee: SAMSUNG ELECTRO-MECHANICS CO., LTD., Suwon (KR)

(21) Appl. No.: 13/874,937

(22) Filed: May 1, 2013

(30) Foreign Application Priority Data
Dec. 28, 2012 (KR) 10-2012-0157035

(51) Int. Cl. H05B 33/08

(52) U.S. Cl. CPC H05B 33/083
USPC 315/122

(57) ABSTRACT

There is provided a light emitting diode driving device capable of preventing a number of switches from being turned on simultaneously when a plurality of light emitting diodes are respectively driven using a plurality of switches, the light emitting diode driving device, including: a light emitting diode unit having a plurality of light emitting diodes connected to one another in series and emitting light through receiving rectified power; and a driving unit having a plurality of drivers driving the plurality of light emitting diodes of the light emitting diode unit, respectively, wherein each of the plurality of drivers selects a maximum voltage from among a plurality of detection voltages with respect to current flowing in at least one light emitting diode corresponding thereto and compares the maximum voltage with a preset reference voltage to thereby drive the corresponding light emitting diode.

### CROSS-REFERENCE TO RELATED APPLICATIONS

This application claims the priority of Korean Patent Application No. 10-2012-0157035 filed on Dec. 28, 2012, in the Korean Intellectual Property Office, the disclosure of which is incorporated herein by reference.

### BACKGROUND OF THE INVENTION

1. Field of the Invention

The present invention relates to a light emitting diode driving device for directly driving light emitting diodes with alternating current (AC) power.

2. Description of the Related Art

Alight emitting diode (LED) is a semiconductor device having a p-n junction structure emitting light through electron-hole recombination, and has recently had applications in a number of fields, according to the development of semiconductor technology. Particularly, since LEDs have high degrees of efficiency, relatively long lifespans, and environmentally friendly properties as compared to various types of light emitting devices according to the related art, a field of application thereof is continuously being broadened.

Generally, LEDs can be driven by applying several volts of direct current (DC) power thereto, in light of a structure thereof. Therefore, in order to drive LEDs using commercial alternating current (AC) power, a separate device element is required. In order to drive LEDs using commercial AC power, an LED driving device typically includes a rectifying circuit, an AC-DC converter, or the like.

However, a general AC-DC converter has a relatively large volume and consumes significant amounts of power. Therefore, in the case in which a general AC-DC converter is applied to an LED driving device, advantages of LEDs, such as high-efficiency, small packaging size, long lifespan, and the like, are largely nullified.

Therefore, research into an LED driving device capable of directly driving LEDs with AC power, without using an AC-DC converter, has recently been conducted.

In the case of directly driving LEDs with AC power without using an AC-DC converter, a method in which a plurality of switches are connected to a plurality of LEDs, respectively, and switching on and switching off of the plurality of switches are controlled according to levels of AC power to allow current to flow continuously may be generally applied.

Patent Document 1 relates to an LED driving device directly driving LEDs using AC power, by controlling operations of switches connected to an intermediate node and the last node of an LED array. Patent Document 2 also relates to an LED driving device capable of controlling switching on and switching off of switches based on an order of the switches to which an LED array is connected.

Both Patent Documents 1 and 2 control the operations of the switches in order to drive LEDs; however, in the case in which the plurality of switches are driven, a number of switches may be turned on simultaneously, thereby causing difficulties in the driving of LEDs, and degrading power factor and total harmonic distortion (THD) characteristics.

### RELATED ART DOCUMENT

(Patent Document 1) Korean Patent No. 10-0997050

(Patent Document 2) Korean Patent No. 10-0995793

### SUMMARY OF THE INVENTION

An aspect of the present invention provides a light emitting diode driving device capable of preventing a number of switches from being turned on simultaneously in the case in which a plurality of light emitting diodes are respectively driven using a plurality of switches.

According to an aspect of the present invention, there is provided a light emitting diode driving device, including: a light emitting diode unit having a plurality of light emitting diodes connected to one another in series and emitting light through receiving rectified power; and a driving unit having a plurality of drivers driving the plurality of light emitting diodes of the light emitting diode unit, respectively, wherein each of the plurality of drivers selects a maximum voltage from among a plurality of detection voltages with respect to current flowing in at least one light emitting diode corresponding thereto and compares the maximum voltage with a preset reference voltage to thereby drive the corresponding light emitting diode.

The preset reference voltage input to the plurality of drivers may be set to have different voltage levels.

A voltage level of a reference voltage of a front end driver among the plurality of drivers may be set to be equal to or less than that of a reference voltage of a rear end driver adjacent thereto.

Each of the plurality of drivers may detect the current flowing in the corresponding light emitting diode and divides the detected voltage to thereby form the plurality of detection voltages, and at least one of a plurality of detection voltages of a rear end driver among the plurality of drivers may be transferred to a front end driver adjacent thereto.

Each of the plurality of drivers may include a comparator selecting the maximum voltage from among the plurality detection voltages to compare the selected voltage with the reference voltage; a switch switched on and switched off according to a comparison result of the comparator to allow current to flow in the corresponding light emitting diode; and a resistor group having a plurality of resistors connected to one another in series between the switch and a ground to detect the current flowing in the corresponding light emitting diode, and providing the plurality of detection voltages.

The switch may be connected to a cathode of the corresponding light emitting diode.

The comparator may include a level shifter group having a plurality of level shifters adjusting respective voltage levels of the plurality of detection voltages; a current source group having a plurality of current sources respectively supplying current according to the adjusting of the voltage levels by the level shifters; a maximum voltage detection unit detecting the maximum voltage from among the plurality of detection voltages level-adjusted from the level shifter group; a current mirror mirroring the maximum voltage detected by the maximum voltage detection unit; and an amplifying unit amplifying the mirrored voltage from the current mirror.

Each of the plurality of drivers may form at least two detection voltages having different voltage levels, a detection voltage having a lower voltage level of the at least two detection voltages of the rear end driver among the plurality of drivers may be transferred to the front end driver adjacent to the rear end driver, and a detection voltage having a higher voltage level of the least two detection voltages may be transferred to a front end driver of the front end driver adjacent to the rear end driver.

The light emitting diode driving device may further include a rectifying unit rectifying alternating current (AC) power to supply rectified AC power to the light emitting diode unit.

According to another aspect of the present invention, there is provided a light emitting diode driving device, including: a light emitting diode unit having a plurality of light emitting diodes connected to one another in series and emitting light through receiving rectified power; and a driving unit having a plurality of drivers driving the plurality of light emitting diodes of the light emitting diode unit, respectively, wherein each of the plurality of drivers selects a maximum voltage from among a plurality of detection voltages with respect to current flowing in at least one light emitting diode corresponding thereto and compares the maximum voltage with a preset reference voltage to thereby drive the corresponding light emitting diode, the plurality of drivers include first to Nth drivers (N is a natural number of 2 or more), a first driver receives a first detection voltage having a low voltage level from a second driver and a second detection voltage having a high voltage level from third to Nth drivers, of the first and second detection voltages with respect to current flowing in at least one light emitting diode corresponding thereto, and compares a maximum voltage among the received detection voltages with a reference voltage to thereby drive the corresponding light emitting diode, second to N-2nd drivers receive a first detection voltage from a rear end driver, receive a second detection voltage from a rear end driver of the rear end driver, and compare a maximum voltage among the received detection voltages with a reference voltage to thereby drive light emitting diodes corresponding thereto, and a N-1st driver receives a first detection voltage from a Nth driver, and the Nth driver receives a sensing voltage from a sensing resistor detecting current flowing in light emitting diodes corresponding thereto to compare the received voltage with a reference voltage to thereby drive the corresponding light emitting diodes.

Each of the plurality of drivers may include a comparator selecting the maximum voltage from among the plurality detection voltages to compare the selected voltage with the reference voltage; a switch switched on and switched off according to a comparison result of the comparator to allow current to flow in the corresponding light emitting diodes; and a resistor group having a plurality of resistors connected to one another in series between the switch and the sensing resistor to detect the current flowing in the corresponding light emitting diodes, and providing the plurality of detection voltages.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic configuration diagram of a light emitting diode driving device according to an embodiment of the present invention;

FIG. 2 is a schematic circuit diagram of a driver employed in the light emitting diode driving device according to the embodiment of the present invention;

FIG. 3 is a schematic circuit diagram of a comparator of the driver employed in the light emitting diode driving device according to the embodiment of the present invention;

FIG. 4 is a schematic circuit diagram of the light emitting diode driving device according to the embodiment of the present invention; and

FIGS. 5 through 7 are graphs showing electrical characteristics of the light emitting diode driving device according to the embodiment of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same or like reference numerals will be used throughout to designate the same or like elements.

It will be understood that when an element is referred to as being “connected to” another element, it can be directly connected thereto or may be indirectly connected thereto having element(s) interposed therebetween.

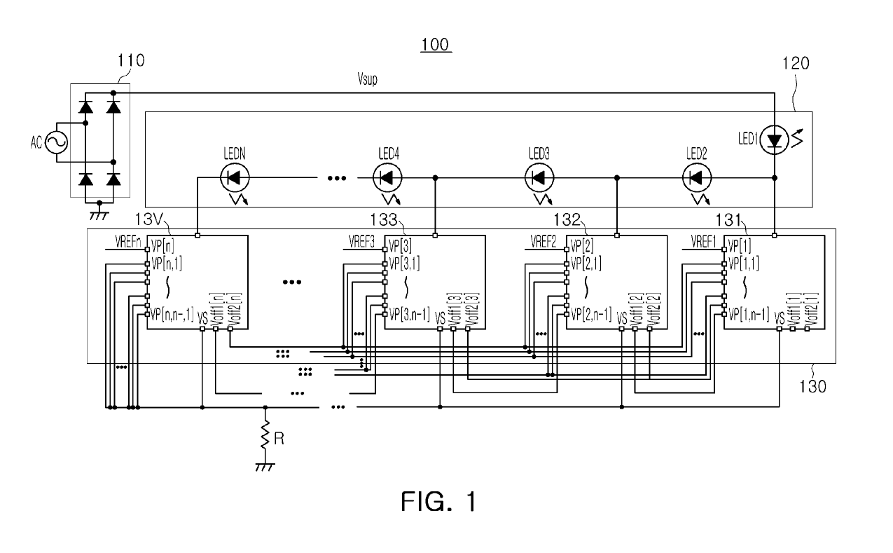

FIG. 1 is a schematic configuration diagram of a light emitting diode driving device according to an embodiment of the invention.

Referring to FIG. 1, a light emitting diode driving device 100 according to the present embodiment may include a rectifying unit 110, a light emitting diode unit 120, and a driving unit 130.

The rectifying unit 110 may receive alternating current (AC) power to full-wave rectify or half-wave rectify the received AC power, and may supply the rectified power to the light emitting diode unit 120 to provide power capable of driving the light emitting diode unit 120.

The light emitting diode unit 120 may include a plurality of light emitting diodes connected to one another in series, and the light emitting diodes may perform respective light emitting operations due to drivers of the driving unit 130 corresponding thereto.

The driving unit 130 may drive the plurality of light emitting diodes of the light emitting diode unit 120, and may include a plurality of drivers 131 to 13N in order to drive the plurality of light emitting diodes, respectively.

First to Nth drivers 131 to 13N may correspond to first to Nth light emitting diodes LED1 to LEDN of the light emitting diode unit 120 to thereby drive one or more light emitting diodes corresponding thereto.

More specifically, the first driver 131 drives the first light emitting diode LED1, and when a voltage level of the rectified power from the rectifying unit 110 is increased, the first driver 131 stops operating and the second driver 132 drives the first and second light emitting diodes LED1 and LED2. By the sequential operation as described above, the Nth driver 13N may drive the first to Nth light emitting diodes LED1 to LEDN.

In this case, for example, while the third driver 133 drives the first to third light emitting diodes LED1 to LED3, a problem in which the first driver 131 is operated to drive the first light emitting diode LED1 may occur.

In order to solve this problem, the plurality of driviers may detect current flowing in the corresponding light emitting diodes and form a plurality of detection voltages, such that simultaneous driving operations thereof may be prevented by using the plurality of detection voltages.

That is, the plurality of detection voltages may be transferred to adjacent drivers and the drivers receiving the detection voltages compare a maximum voltage among the received detection voltages with a preset reference voltage, such that the driving of light emitting diodes corresponding thereto may be controlled according to the comparison result.

For example, in the case of forming first and second detection voltages Voff1 and Voff2, a first detection voltage Voff1[2] having a low voltage level among the detection voltages of the second driver 132 may be transferred to the first driver 131, a first detection voltage Voff1[3] of the third driver 133 may be transferred to the second driver 132, and a second detection voltage Voff2[3] having a high voltage level among the detection voltages of the third driver 133 may be transferred to the first driver 131. Such a relationship may be extended, and the detection voltages transferred to the drivers may be proportional to the number of drivers.

However, a detection voltage transferred to the last Nth driver 13N may be a sensing voltage detected by a sensing resistor R detecting the current flowing in the first through Nth light emitting diodes, and a detection voltage transferred to a N-1st driver (not shown) may be a first detection voltage Voff1[n] of the Nth driver 13N. A second detection voltage Voff2[n] of the Nth driver 13N may be transferred to a N-2nd driver (not shown), and first and second detection voltages of the N-1st driver may be transferred to N-2nd and N-3rd drivers (not shown), respectively.

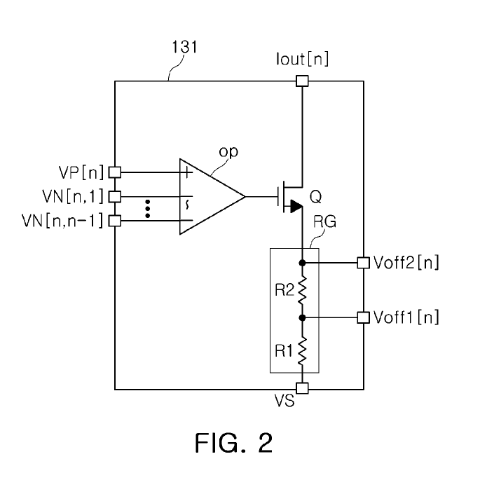

FIG. 2 is a schematic circuit diagram of a driver employed in the light emitting diode driving device according to the embodiment of the invention.

Referring to FIGS. 1 and 2, each of the first through Nth drivers 131 through 13N may include a comparator op, a switch Q, and a dividing resistor group R1 and R2.

The comparator op may compare a preset reference voltage with a maximum voltage among a plurality of detection voltages and may switch the switch Q on and off according to the comparison result.

The switch Q may control current flowing in light emitting diodes corresponding thereto according to the comparison result of the comparator op.

The dividing resistor group may include first and second resistors R1 and R2, and may be formed between the corresponding light emitting diode and a ground to thereby form first and second detection voltages Voff1 and Voff2. The dividing resistor group may be connected to the ground through the sensing resistor R.

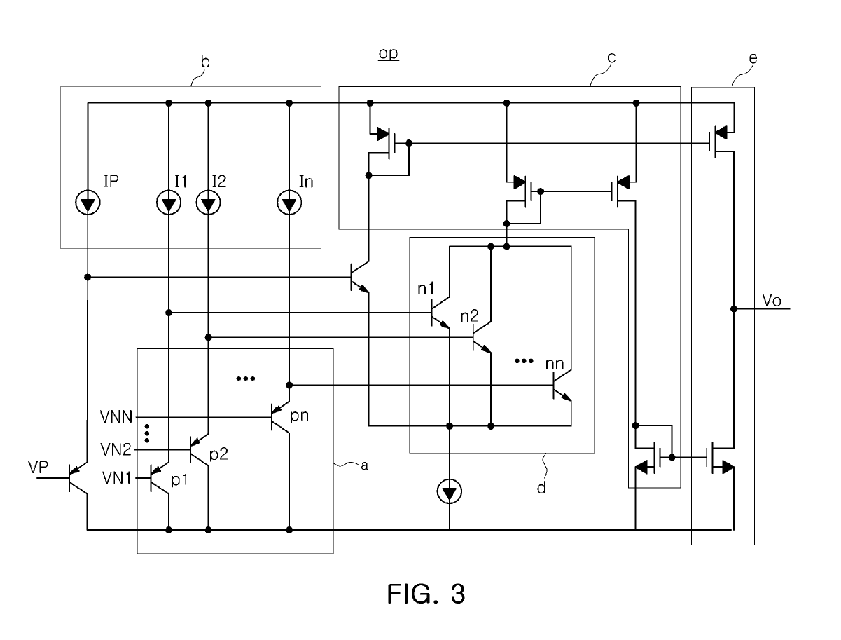

FIG. 3 is a schematic circuit diagram of a comparator of the driver employed in the light emitting diode driving device according to the embodiment of the invention.

Referring to FIG. 3, the comparator op may include a level shifter group a having a plurality of level shifters adjusting respective voltage levels of a plurality of detection voltages, a current source group b having a plurality of current sources supplying current according to the level adjustment of the level shifters, a maximum voltage detection unit d detecting a maximum voltage among the plurality of detection voltages level-adjusted from the level shifter group a, a current mirror c mirroring the maximum voltage detected by the maximum voltage detection unit d, and an amplifying unit e amplifying the mirrored voltage from the current mirror c.

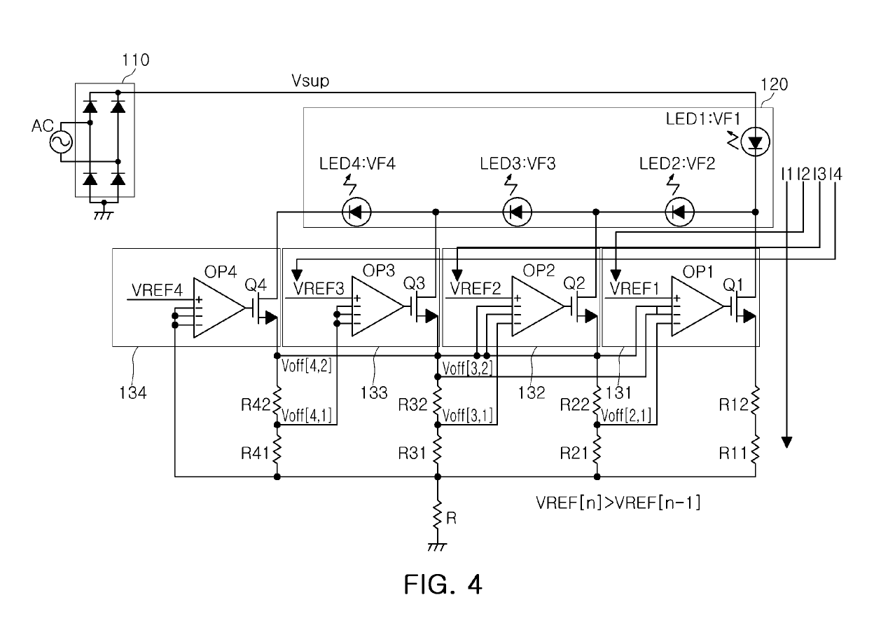

FIG. 4 is a schematic circuit diagram of the light emitting diode driving device according to the embodiment of the invention.

Referring to FIG. 4, for example, the light emitting diode unit 120 may include first to fourth light emitting diodes LED1, LED2, LED3, and LED4. Therefore, the driving unit 130 may include first to fourth drivers 131, 132, 133, and 134.

The first driver 131 may drive the first light emitting diode LED1; the second driver 132 may drive the first and second light emitting diodes LED1 and LED2 after the operation of the first driver 131 is stopped; the third driver 133 may drive the first to third light emitting diodes LED1, LED2, and LED3 after the operations of the first and second drivers 131 and 132 are stopped; and the fourth driver 134 may drive the first to fourth light emitting diodes LED1 to LED4 after the operations of the first to third drivers 131, 132, and 133 are stopped. At this time, a case in which the drivers are simultaneously operated may occur. This unnecessarily consumes power, so that power factor and total harmonic distortion (THD) characteristics may be deteriorated.

In the case in which the voltage level of the rectified power is increased, the description with respect to FIG. 1 may be referred to. In the case in which the voltage level of the rectified power is decreased, assuming that respective reference voltages are the same, when the voltage level of the rectified power is close to threshold voltages of the first to fourth light emitting diodes, current for operating a switch Q4 of the fourth driver 134 is decreased, and then, when the voltage level of the rectified power is further reduced, a switch Q3 of the third driver 133 is automatically operated. In this case, before the switch Q3 of the third driver 133 is completely and normally operated, the switch Q4 of the fourth driver 134 and the switch Q3 of third driver 133 may be simultaneously operated. Thereafter, a detection voltage having a higher voltage level than those of detection voltages of comparators op1 and op2 of the first and second drivers 131 and 132 is input to a comparator op3 of the third driver 133, such that the switch Q3 of the third driver 133 may be smoothly operated.

The plurality of detection voltages as described above may be provided from adjacent drivers.

For example, the first driver 131 may receive a first detection voltage from the second driver 132, and may receive a second detection voltage having a higher voltage level than that of the first detection voltage from the third and fourth drivers 133 and 134.

The second driver 132 may also receive a second detection voltage from the fourth driver 134, and may receive a first detection voltage from the third driver 133.

The third driver 133 may only receive a first detection voltage from the fourth driver 134, and the fourth driver 134 may only receive a sensing voltage from the sensing resistor R.

Meanwhile, reference voltages transferred to respective drivers may be varied, such that current flowing in light emitting diodes corresponding thereto may be adjusted.

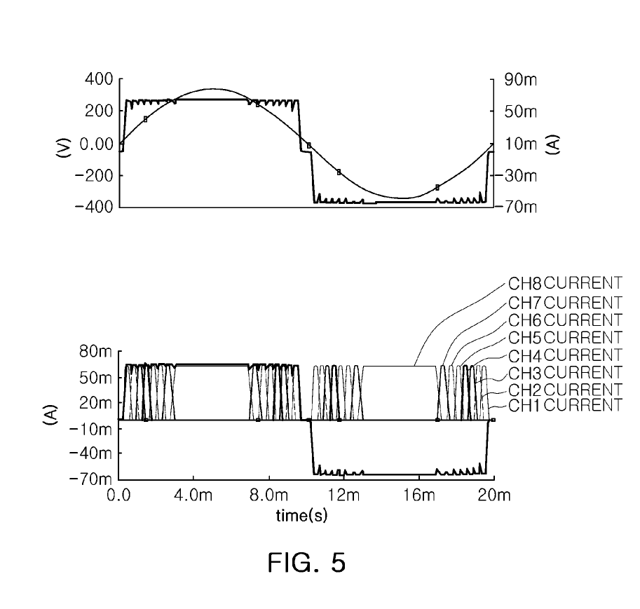

FIGS. 5 through 7 are graphs showing electrical characteristics of the light emitting diode driving device according to the embodiment of the invention.

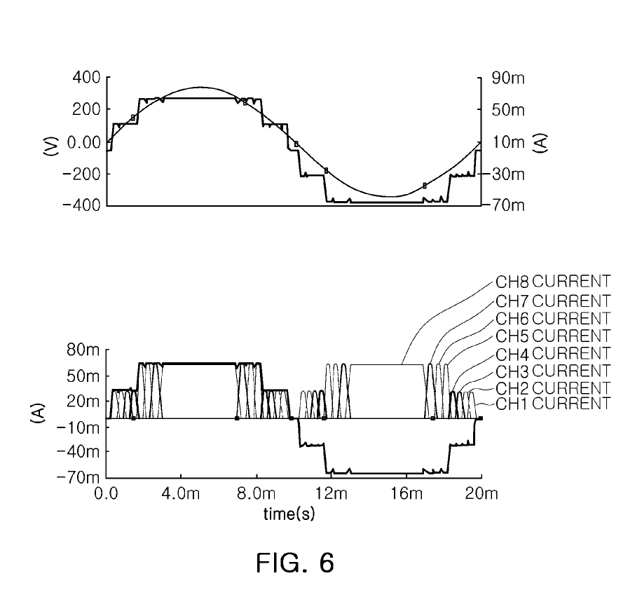

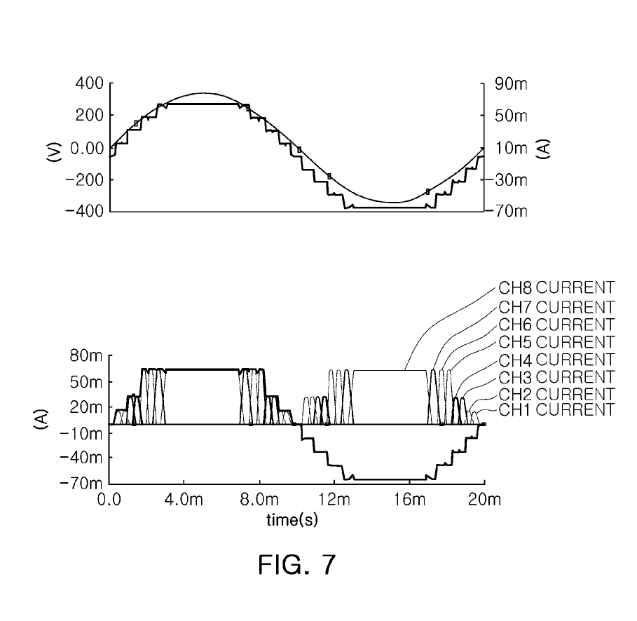

With reference to FIGS. 5 through 7, when the light emitting diode driving device according to the embodiment of the invention is operated to drive eight light emitting diodes, it may be appreciated that the light emitting diode driving device is operated normally in the case in which current of the light emitting diodes of respective channels is maintained to have the same level as one another (FIG. 5), in the case in which current of the fifth to eighth light emitting diodes is set to be twice as high as current of the first through fourth light emitting diodes (FIG. 6), or in the case in which current of the first and second light emitting diodes, current of the third and fourth light emitting diodes, current of the fifth and sixth light emitting diodes, and current of the seventh and eighth light emitting diodes are respectively set to be the same as, twice as high as, three times as high as and four times as high as the current of the first and second light emitting diodes (FIG. 7).

As set forth above, according to embodiments of the invention, in the case in which a plurality of light emitting diodes are respectively driven using a plurality of switches, a plurality of detection voltages may be formed and a maximum voltage among the plurality of detection voltages may be compared with a preset reference voltage, such that a corresponding switch may be smoothly operated. In this manner, a problem in which a number of switches are turned on simultaneously may be addressed, and thus power factor and total harmonics distortion (THD) characteristics may be improved.

While the present invention has been shown and described in connection with the embodiments, it will be apparent to those skilled in the art that modifications and variations can be made without departing from the spirit and scope of the invention as defined by the appended claims.

What is claimed is:

1. A light emitting diode driving device, comprising:
a light emitting diode unit having a plurality of light emitting diodes connected to one another in series and emitting light through receiving rectified power; and
a driving unit having a plurality of drivers driving the plurality of light emitting diodes of the light emitting diode unit, respectively,
wherein each of the plurality of drivers selects a maximum voltage from among a plurality of detection voltages with respect to current flowing in at least one light emitting diode corresponding thereto and compares the maximum voltage with a preset reference voltage to thereby drive the corresponding light emitting diode.

2. The light emitting diode driving device of claim 1, wherein the preset reference voltage input to the plurality of drivers is set to have different voltage levels.

3. The light emitting diode driving device of claim 2, wherein a voltage level of a reference voltage of a front end driver among the plurality of drivers is set to be equal to or less than that of a reference voltage of a rear end driver adjacent thereto.

4. The light emitting diode driving device of claim 1, wherein each of the plurality of drivers detects the current flowing in the corresponding light emitting diode and divides the detected voltage to thereby form the plurality of detection voltages, and
at least one of a plurality of detection voltages of a rear end driver among the plurality of drivers is transferred to a front end driver adjacent thereto.

5. The light emitting diode driving device of claim 1, wherein each of the plurality of drivers includes:
a comparator selecting the maximum voltage from among the plurality detection voltages to compare the selected voltage with the reference voltage;
a switch switched on and switched off according to a comparison result of the comparator to allow current to flow in the corresponding light emitting diode; and
a resistor group having a plurality of resistors connected to one another in series between the switch and a ground to detect the current flowing in the corresponding light emitting diode, and providing the plurality of detection voltages.

6. The light emitting diode driving device of claim 5, wherein the switch is connected to a cathode of the corresponding light emitting diode.

7. The light emitting diode driving device of claim 5, wherein the comparator includes:
a level shifter group having a plurality of level shifters adjusting respective voltage levels of the plurality of detection voltages;
a current source group having a plurality of current sources respectively supplying current according to the adjusting of the voltage levels by the level shifters;
a maximum voltage detection unit detecting the maximum voltage from among the plurality of detection voltages level-adjusted from the level shifter group;
a current mirror mirroring the maximum voltage detected by the maximum voltage detection unit; and
an amplifying unit amplifying the mirrored voltage from the current mirror.

8. The light emitting diode driving device of claim 4, wherein each of the plurality of drivers forms at least two detection voltages having different voltage levels,
a detection voltage having a lower voltage level of the at least two detection voltages of the rear end driver among the plurality of drivers is transferred to the front end driver adjacent to the rear end driver, and
a detection voltage having a higher voltage level of the least two detection voltages is transferred to a front end driver of the front end driver adjacent to the rear end driver.

9. The light emitting diode driving device of claim 1, further comprising a rectifying unit rectifying alternating current (AC) power to supply rectified AC power to the light emitting diode unit.

10. A light emitting diode driving device, comprising:
a light emitting diode unit having a plurality of light emitting diodes connected to one another in series and emitting light through receiving rectified power; and
a driving unit having a plurality of drivers driving the plurality of light emitting diodes of the light emitting diode unit, respectively,
wherein each of the plurality of drivers selects a maximum voltage from among a plurality of detection voltages with respect to current flowing in at least one light emitting diode corresponding thereto and compares the maximum voltage with a preset reference voltage to thereby drive the corresponding light emitting diode,
the plurality of drivers include first to Nth drivers (N is a natural number of 2 or more),
a first driver receives a first detection voltage having a low voltage level from a second driver and a second detection voltage having a high voltage level from third to Nth drivers, of the first and second detection voltages with respect to current flowing in at least one light emitting diode corresponding thereto, and compares a maximum voltage among the received detection voltages with a reference voltage to thereby drive the corresponding light emitting diode,
second to N-2nd drivers receive a first detection voltage from a rear end driver, receive a second detection voltage from a rear end driver of the rear end driver, and compare a maximum voltage among the received detection voltages with a reference voltage to thereby drive light emitting diodes corresponding thereto, and
a N-1st driver receives a first detection voltage from a Nth driver, and the Nth driver receives a sensing voltage from a sensing resistor detecting current flowing in light emitting diodes corresponding thereto to compare the received voltage with a reference voltage to thereby drive the corresponding light emitting diodes.

11. The light emitting diode driving device of claim 10, wherein the preset reference voltage input to the plurality of drivers is set to have different voltage levels.

12. The light emitting diode driving device of claim 11, wherein a voltage level of a reference voltage of a front end driver among the plurality of drivers is set to be equal to or less than that of a reference voltage of a rear end driver adjacent thereto.

13. The light emitting diode driving device of claim 10, wherein each of the plurality of drivers includes:
a comparator selecting the maximum voltage from among the plurality detection voltages to compare the selected voltage with the reference voltage;
a switch switched on and switched off according to a comparison result of the comparator to allow current to flow in the corresponding light emitting diodes; and
a resistor group having a plurality of resistors connected to one another in series between the switch and the sensing resistor to detect the current flowing in the corresponding light emitting diodes, and providing the plurality of detection voltages.

14. The light emitting diode driving device of claim 13, wherein the comparator includes:
a level shifter group having a plurality of level shifters adjusting respective voltage levels of the plurality of detection voltages;
a current source group having a plurality of current sources respectively supplying current according to the adjusting of the voltage levels by the level shifters;
a maximum voltage detection unit detecting the maximum voltage among the plurality of detection voltages level-adjusted from the level shifter group;
a current mirror mirroring the maximum voltage detected by the maximum voltage detection unit; and
an amplifying unit amplifying the mirrored voltage from the current mirror.

15. The light emitting diode driving device of claim 10, further comprising a rectifying unit rectifying alternating current (AC) power to supply rectified AC power to the light emitting diode unit.
